(19) United States
(12) Patent Application Publication
(10) Pub. No.: US 2004/0117238 A1
(43) Pub. Date: Jun. 17, 2004

(54) Transactions involving agricultural inputs

(76) Inventors: Dennis Inman, Eden Prairie, MN (US); Frank M. Remley, Lakeville, MN (US); Jeffery Seeley, Chanhassen, MN (US); Wallace E. Palm, Plymouth, MN (US)

Correspondence Address: Paula A. DeGrandis, Cargill, Inc., Law Department, MS 24, P.O. Box 5624, Minneapolis, MN, 55440-5624, US

(21) Appl. No.: 10/319,410

(22) Filed: Dec. 12, 2002

(51) Int. Cl. G06F 17/60

(52) U.S. Cl. 705/10

(57) ABSTRACT

The invention is directed to business methods involving inputs used to produce an agricultural product. In exchange for a promise to pay a package price to a “provider,” the agricultural producer receives inputs for producing the agricultural product, a performance guarantee in the event of input performance failure, and protection against a falling market price for the agricultural product during the growing season. The agricultural producer may also receive a deferred payment benefit, plus additional services.

### TECHNICAL FIELD

The invention relates to the agriculture business and, more particularly, to transactions involving inputs used to produce agricultural products.

### BACKGROUND

An agricultural producer, desiring to produce an agricultural product, may purchase “inputs” to produce the agricultural product. In the case of an agricultural producer who wishes to grow corn, for example, the inputs may include seed corn and fertilizer, along with crop protection products such as pre-emergent herbicide, post-emergent herbicide and insecticide. The agricultural producer often pays the cost of the inputs at the time of purchase of the inputs, or finances the cost of inputs through a retailer or lending institution, and this cost becomes a substantially fixed cost associated with producing the agricultural product.

In some situations, an agricultural producer may find that additional inputs, i.e., inputs beyond the inputs originally purchased, may be needed. A farmer may apply a herbicide and an insecticide to his crop, for example, and later find that the applications have failed to keep the field “clean,” i.e., to provide adequate control of weeds and pests, thereby threatening the quality and quantity of the crop. To have a clean field, the agricultural producer may need to replant seed or reapply herbicide or insecticide at an additional cost. Even though some crop protection products come with a guarantee or warranty, the agricultural producer may be responsible for a substantial portion of the cost associated with reapplication.

Some agricultural producers pay cash up front for inputs. Others may borrow money from a lender to pay for the inputs. However an agricultural producer chooses to pay for inputs, the agricultural producer hopes that revenue from the sale of the agricultural product will cover the cost of the inputs, as well as other production costs. The agricultural producer also hopes that the revenue will provide a profit.

Whether the agricultural producer will recover the costs of producing the agricultural product and whether the agricultural producer will realize a profit often are not known until the end of the growing season. The agricultural producer receives a payment price upon sale or delivery of the agricultural product. The payment price is usually a function of a market price for the agricultural product, which may rise or fall during the growing season.

### SUMMARY

The invention is directed to methods in which an entity known herein as a “provider” and an agricultural producer may enter into an arrangement in which financial risks to the agricultural producer may be reduced. In particular, the invention may include methods for providing a degree of protection to the agricultural producer from a declining market price. The invention may also include methods for providing a degree of protection against a performance failure of one or more inputs.

In exchange for a promise to pay a fixed package price to the provider, the agricultural producer receives inputs for producing the agricultural product, a performance guarantee in the event of input performance failure, and protection against a falling market price during the growing season. The agricultural producer may also receive a deferred payment benefit, plus additional services.

In one embodiment of the invention, the inputs may be selected by the agricultural producer from a menu provided by the provider. The provider may then procure, from one or more manufacturers, distributors or other input suppliers, a package of inputs that includes the inputs selected from the menu. In another embodiment of the invention, the inputs may be selected by the provider.

The methods encompass different forms of protection from input performance failure. In general, input performance failure refers to a failure of performance of an input that threatens the quality or quantity of the agricultural product. In one embodiment, the provider promises to make a payment in the event costs of an input performance failure are not reimbursed by an input supplier, such as the manufacturer or distributor of the input. In another embodiment, the provider promises to remedy input performance failures. In one embodiment, the provider is responsible for delivering a clean field, i.e., a field that meets agreed-upon standards for weed or pest control. The agreed-upon standards may include, for example, “university guidelines” for weed competitiveness or insect damage. In that embodiment, the agricultural producer will not be at risk of paying further amounts because of input performance failure. The provider and agricultural producer may agree that the agricultural producer will apply the inputs to the field, or the parties may agree to have the provider do so.

The methods also encompass degrees of price protection. An agricultural producer who purchases inputs in the conventional fashion treats the purchases as a fixed cost. The fixed cost may or may not be recovered when the agricultural producer sells the agricultural product, depending upon the market price for the agricultural product. The invention provides for the package price to be adjusted downward, to the benefit of the agricultural producer, when the market price for the agricultural product falls. A method for determining whether a market price has fallen includes selecting a reference price and a measure of market price. If the measure of market price is below the reference price, then the market price has fallen. The package price may be adjusted downward as a function of the difference between the reference price and the measure of market price. The package price may also be adjusted upward in the event the market price has risen.

The methods may further include deferred payment benefits. With deferred payment benefits, the agricultural producer need not pay up front for inputs, services, a performance guarantee, price protection, or any other products or services included in the package price. Instead, the agricultural producer may pay the package price from the proceeds of sale of the agricultural product.

In one embodiment, the invention is directed to a method for determining whether a market price for an agricultural product has fallen. The method includes selecting a reference price and a measure of market price. The method also includes reducing a package price when the measure of market price is below the reference price. The measure of market price and the reference price may be determined by observing futures prices of traded commodities. The price protection method may be combined with a performance guarantee or deferred payment benefits.

In another embodiment, the invention is directed to a method comprising promising to take action to make a field clean during a growing season. The method also includes receiving a package price in exchange for the promise, the package price including the price of at least one input for production of an agricultural product on the field. This embodiment, directed to one kind of performance guarantee, may be combined with a price protection guarantee or deferred payment benefits.

In a further embodiment, the invention is directed to a method comprising presenting a menu of agricultural product inputs to an agricultural producer, receiving a selection of inputs from the menu by the agricultural producer, and computing a package price as a function of the selected inputs. The method also includes selecting a reference price and a measure of market price, and reducing the package price when the measure of market price is below the reference price.

In an additional embodiment, the invention is directed to a method comprising computing a package price, the package price including a price for a guarantee of performance of at least one agricultural product input. The method also includes selecting a reference price and a measure of market price, and reducing the package price when the measure of market price is below the reference price.

In further embodiments, the invention is directed to systems that carry out the methods of the invention, and the computer-readable media that include instructions for causing a programmable processor to carry out the methods. Some embodiments present a system comprising a menu manager and a package price calculator. The menu manager presents a menu of agricultural product inputs to an agricultural producer and receives a selection of inputs from the menu by the agricultural producer. The package price calculator computes a package price as a function of the selected inputs, and reduces the package price when a measure of market price selected at a second time is below a reference price selected at a first time.

Other embodiments present a system that includes an input selector and a package price calculator. The input selector selects at least one agricultural product input from a set of agricultural product inputs.

In another embodiment, the invention is directed to a system that comprises a database storing information about a set of agricultural product inputs, and a server. The server performs actions as a function of a selection by an agricultural producer. When the agricultural producer selects a first performance guarantee, the server presents an interface to an agricultural producer for selecting at least one input from the set of agricultural product inputs. When the agricultural producer selects a second performance guarantee, the server selects at least one input from the set.

The details of one or more embodiments of the present invention are set forth in the accompanying drawings and the description below. Other features, objects, and advantages of the present invention will be apparent from the description and drawing, and from the claims.

### DESCRIPTION OF DRAWINGS

FIG. 1 is a diagram illustrating the interaction between an agricultural producer, a provider, and an input manufacturer or distributor, according to one embodiment of the invention.

FIG. 2 is a flow diagram illustrating methods for creating the interaction shown in FIG. 1.

FIG. 3 is a flow diagram illustrating a method for determining whether a package price should be adjusted in accordance with the price protection as shown in FIGS. 1 and 2.

FIG. 4 is a diagram illustrating the interaction between an agricultural producer, a provider, and an input manufacturer or distributor, according to another embodiment of the invention.

FIG. 5 is a flow diagram illustrating methods for creating the interaction shown in FIG. 4.

FIG. 6 is a block diagram illustrating an example of a network-based system that may implement the methods of the invention.

FIG. 7 illustrates an example interface presented to an agricultural producer by a provider over a network.

FIG. 8 is a block diagram illustrating a management system that may implement the network-based system shown in FIG. 6.

### DETAILED DESCRIPTION

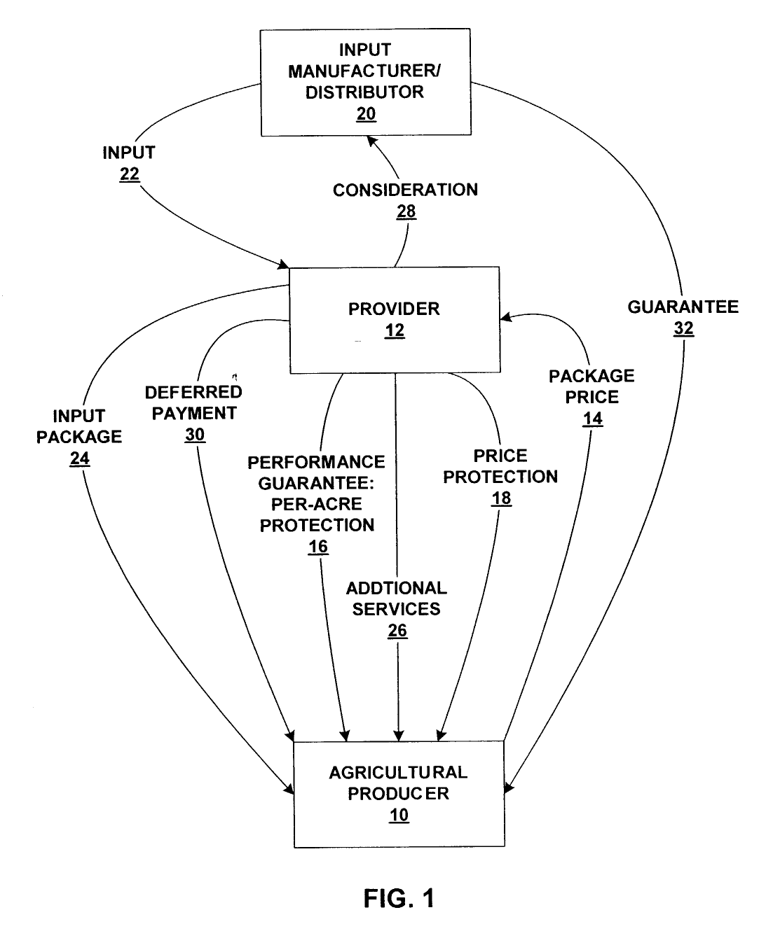

FIG. 1 is a diagram illustrating a method according to one embodiment of the invention, in which an agricultural producer 10 and a provider 12 enter into an arrangement. The term “agricultural producer” may refer to any producer of agricultural products, from an individual farmer or rancher to a large corporate farming operation. “Agricultural products” produced by agricultural producer 10 may take the form of crops such as grain, vegetables, fruit, cotton, and the like. Although the agricultural products discussed below will center upon crops such as corn, the use of corn is simply an illustrative commodity. The invention is not limited to crops in general or to corn in particular. “Agricultural product” also may include livestock or animal produce, as well as any byproducts of the foregoing products.

Provider 12, in exchange for a promise from agricultural producer 10 to pay a “package price” 14, provides a performance guarantee 16 and price protection 18. A “provider” may be any person or entity. Provider 12 may be, for example, a buyer of the agricultural product, a supplier of agricultural services, or a supplier of one or more inputs. Package price 14 includes the price of various inputs and services, as described below, plus the price of performance guarantee 16 and price protection 18.

In the exemplary arrangement shown in FIG. 1, an input manufacturer or distributor 20 provides one or more inputs 22 to provider 12. A “manufacturer or distributor 20” may be any person or entity that supplies inputs. In a typical arrangement, provider 12 may procure inputs 22 from several such manufacturers/distributors 20, but only one manufacturer/distributor 20 is shown in FIG. 1 for simplicity. Provider 12 delivers the inputs to agricultural producer 10 as an input package 24.

An “input” may include any product used to produce an agricultural product. As noted above, “input” may include seed, fertilizer and crop protection products. The term “input” is not limited to those products, however. “Input” may include, for example, water for irrigation, feed or feed byproducts for livestock, machinery used in production, fuel, freight and the like. For purposes of illustrating the invention, inputs discussed below will focus upon seed and crop protection products.

In an exemplary implementation of the arrangement shown in FIG. 1, provider 12 may supply a “menu” of inputs to agricultural producer 10, and agricultural producer 10 may select one or more inputs from the menu, with the quantity desired of each selected input. When the inputs pertain to the production of an agricultural product, the menu may include a selection of application rates, i.e., the quantity of the selected input (which may be expressed in units such as pounds) to be applied per unit of area (which may be expressed in units such as acres). Provider 12 includes the selected inputs in input package 24.

Package price 14 includes the cost of inputs 22 selected from the menu and included in input package 24. Package price 14 may also reflect the cost of additional services 26 to be provided by provider 12. Additional services 26 may include, for example, planting or fertilizing, or applying herbicide or pesticide. Many agricultural producers may prefer to perform such operations themselves, but others may prefer to have provider 12 perform them. The price for the selected inputs at particular application rates, plus the price of additional services 26, if any, may be included in package price 14.

Provider 12 procures one or more inputs 22 from manufacturer/distributor 20, or from several manufacturers/distributors, in exchange for consideration 28. Consideration 28 may comprise, for example, an up-front cash payment. Additional considerations (not shown in FIG. 1) may be exchanged between provider 12 and manufacturer/distributor 20. For example, manufacturer/distributor 20 may provide a discount to provider 12, or may pay provider 12 a fee for inclusion of inputs on the menu presented to agricultural producer 10.

Provider 12 does not necessarily receive payment of package price 14 from agricultural producer 10 up front, however. Instead, provider 12 may provide agricultural producer 10 with deferred payment terms 30. Under deferred payment terms 30, agricultural producer 10 promises to pay all or part of package price 14 at a later time. The time of payment of package price 14 may be, for example, the time that the agricultural product is brought to market. As a result, agricultural producer 10 may pay package price 14 from the proceeds of sale of the commodity.

The proceeds from the sale of the crop may be threatened by a number of factors. One of the possible threats to the crop is a non-performance or failure of an input. A typical manufacturer/distributor 20 may provide a guarantee 32 for the manufactured or distributed input. The guarantee may include a promise by manufacturer/distributor 20 to provide compensation in the event supplied input 22 fails to perform. If agricultural producer 10 applies a herbicide to a field, for example, and the herbicide fails to control the target weed or weeds, the manufacturer/distributor 20 may agree to bear part of the cost of a reapplication of the herbicide.

Whether an input has failed to perform may be determined by reference to a standard. As will be discussed below, there are some widely recognized standards that may be used to evaluate whether or not a field is “clean,” i.e., whether an input has adequately performed. The standard may also be specified in the terms of guarantee 32 that accompanies input 22. In addition, guarantee 32 is often a limited guarantee. As a result, agricultural producer 10 may bear a portion of the risk that an input may fail to perform.

Performance guarantee 16 provides protection to agricultural producer 10 beyond that provided by manufacturer/distributor 20. In the embodiment shown in FIG. 1, performance guarantee 16 may be a per-acre guarantee. For example, provider 12 may agree to bear the input performance failure costs not covered by guarantee 32 from manufacturer/distributor 20, up to a maximum, e.g., five dollars per acre. Provider 12 may limit performance guarantee 16 to replacement of the input, and exclude losses such as the costs of reapplication or consequential damages. Performance guarantee 16 therefore reduces the financial risk to agricultural producer 10 in the event one or more inputs in package 24 fail to perform.

Another possible threat to the proceeds from the sale of the crop may be a drop in market price of the agricultural product. Agricultural producers as a group are susceptible to risk factors that can adversely affect the market price of the agricultural product, such as drought, hail, wind, frost, and excess rain, plant disease, insects, market volatility, increased global capacity, and government regulations. In a year in which many agricultural producers are producing high yields of agricultural products, an individual agricultural producer may find it more difficult to realize a profit from an investment in inputs and the labor to turn the inputs into an agricultural product.

Price protection 18 limits the financial risk of agricultural producer 10 to a market downturn. Package price 14 is reduced as a function of the drop in the market price for the agricultural product. Methods for measuring a drop in the market price will be described below.

Price protection 18 and deferred payment 30 work together for the benefit of agricultural producer 10. At the outset of the growing season, agricultural producer 10 may receive a package of inputs 24, but will not have to pay package price 14 until a later date, such as the time of harvest. This is the benefit afforded by deferred payment 30. In addition, package price 14 may be adjusted downward in the event of a drop in the market price, which is the benefit of price protection 18. In this way, provider 12 reduces the financial risk of agricultural producer 10. Agricultural producer 10 need not pay fixed input costs up front, and need not be at a substantial risk of suffering a loss should the market price fall.

The invention encompasses embodiments in which deferred payment terms 30 are not offered. For ease of administration and accounting, however, provider 12 may require that that price protection 18 and deferred payment 30 be a part of the arrangement. In other words, an agricultural producer 10 will not be permitted to pay for inputs 24 in full upon delivery, even if agricultural producer 10 wishes to pay for inputs 24 up front in full. In the event the market price goes down, package price 14 would be adjusted downward pursuant to price protection 18, and the input price at the end of the growing season may be below the price paid by agricultural producer 10 at the outset of the growing season. In such circumstances, provider 12 would owe a refund to agricultural producer 10.

By insisting upon deferred payment 30, provider 12 may be spared the obligation of making a refund under the terms of price protection 18. With deferred payment 30, provider 12 and agricultural producer 10 would “wait and see” before settling accounts. The “wait and see” approach may simplify settlement of accounts.

Some agricultural producers may prefer to pay at least a portion of the price of inputs up front, because of tax reasons or other considerations. Accordingly, provider 12 may also allow agricultural producer 10 the option to pay a part of the price of inputs up front. For example, agricultural producer 10 may be permitted to pay up to seventy-five percent of the price of inputs up front, with twenty-five percent of the price being deferred. Provider 12 and agricultural producer 10 would “wait and see” as to the remaining twenty-five percent of the price of inputs. In this scenario, agricultural producer 10 may realize some benefits of an up-front payment, and provider 12 may reduce the risk that provider 12 would owe a refund to agricultural producer 10.

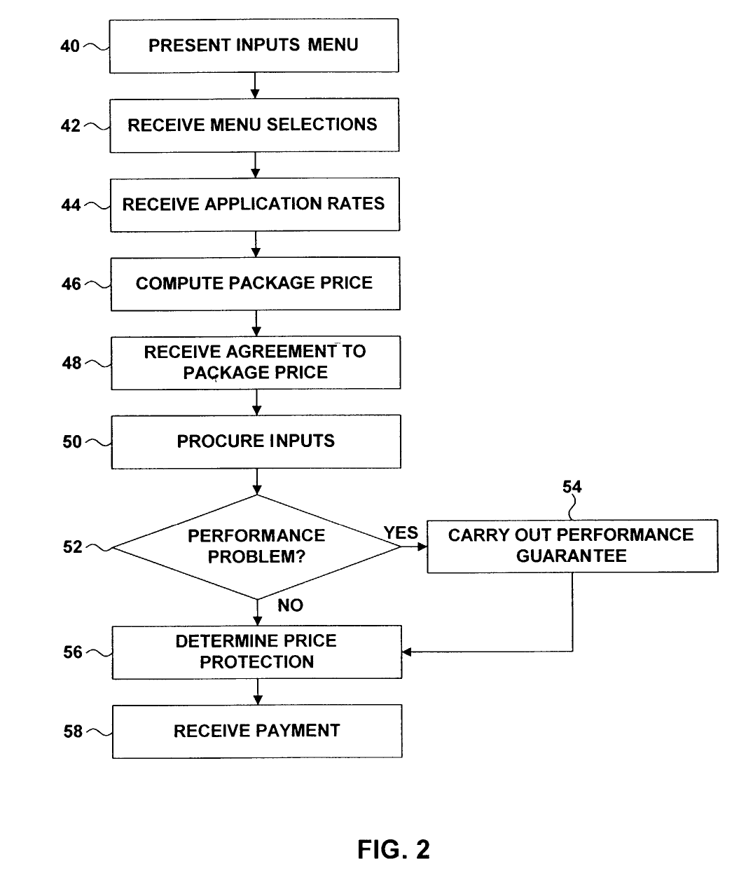

FIG. 2 is a flow diagram that illustrates the general sequence of events in accordance with the arrangement of FIG. 1. The sequence will be described in terms of a crop such as corn, but the same general sequence may be applied to other agricultural products as well. Provider 12 presents a menu of inputs to agricultural producer 10 (40) and receives the menu selections from agricultural producer 10 (42). Agricultural producer 10 may choose, for example, a seed corn, fertilizer, herbicide and insecticide from the menu. The menu may be presented and menu selections may be received via a computer system, such as the system that will be described below.

Provider 12 also receives application rates from agricultural producer 10 (44). The application rates typically specify the desired quantity of each input to be applied per acre. Provider 12 may further receive an order for additional services 26 (not shown in FIG. 2).

On the basis of the selected inputs, the selected application rates, and the selected additional services, if any, provider 12 computes package price 14 (46). Package price 14 may be computed using any of several methods, and the invention is not limited to any particular method. Computation of package price 14 (46) may take into account consideration 28 to be paid by provider 12 to manufacturer/distributor 20, the estimated cost of providing additional services 26, and the costs associated with providing performance guarantee 16, price protection 18, and deferred payment 30.

The costs associated with providing performance guarantee 16 may be computed by any method for pricing risk sharing. The costs associated with performance guarantee 16 may depend, for example, upon the nature and extent of guarantee 32 provided by manufacturer/distributor 20 for a particular input 22. If manufacturer/distributor 20 provides a generous guarantee 32, then the cost of performance guarantee 16 may be low. Because provider 12 prepares the menu of inputs for selection by agricultural producer 10, provider 12 may have knowledge about the nature and extent of the guarantee by manufacturer/distributor 20 accompanying each input on the menu.

Similarly, the costs associated with providing price protection 18 may be computed by any method. Provider 12 may consider, for example, the cost associated with the purchase of derivatives on commodities markets to protect provider 12 from downturns in the market price for the agricultural product.

The costs associated with deferred payment 30 may likewise be computed by any method. Provider 12 may consider, for example, the prevailing interest rate and the credit history of agricultural producer 10. The costs of deferred payment 30 may also take into consideration the percentage of package price 14 that agricultural producer 10 is willing to pay up front.

After agricultural producer 10 agrees to pay package price 14 in exchange for the package of inputs, services and price protection and performance protection (48), provider 12 arranges delivery of inputs (50) from manufacturer/distributor 20. As part of the arrangement, provider 12 may supply consideration 26 to manufacturer/distributor 20. If agricultural producer 10 has agreed to pay for additional

services 26 such as planting or herbicide application services, provider 12 may supply the additional services as agreed (not shown in FIG. 2).

In the event of a performance problem (52), provider 12 carries out performance guarantee 16, if necessary (54). In particular, provider 12 compensates agricultural producer 10 for losses in excess of those covered by guarantee 32, e.g., subject to a per-acre maximum. In some circumstances, guarantee 32 from manufacturer/distributor 20 may make agricultural producer 10 whole, and in that event, provider 12 has no additional obligation to compensate agricultural producer 10 for losses pursuant to performance guarantee 16.

After agricultural producer 10 harvests the crop and takes the crop to market, or at another agreed-upon date, provider 12 determines the amount of benefit to agricultural producer 10 from price protection 18. In particular, provider 12 determines whether the market price of the agricultural product has gone up or down, according to methods such as those described below. If the market price of the agricultural product has gone down, then agricultural producer 10 receives the benefit of price protection 18. In particular, provider 12 adjusts package price 14 downward as a function of the drop in the market price. Provider 12 receives payment from agricultural producer 10 for package price 14, as adjusted (58).

If the market price of the agricultural product has gone up, then agricultural producer 10 receives the benefit of the high market price. In some embodiments of the invention, no adjustment is made to the package price when the market price of the agricultural product rises. In other embodiments of the invention, agricultural producer 10 may agree to share the benefits of the high market price with provider 12. In other words, the package price may be adjusted upward, to the benefit of provider 12, when the market price rises. The package price may be adjusted upward as a function of the difference between the reference price and the measure of market price. In this embodiment, agricultural producer 10 and provider 12 share the risk of changes in the market price.

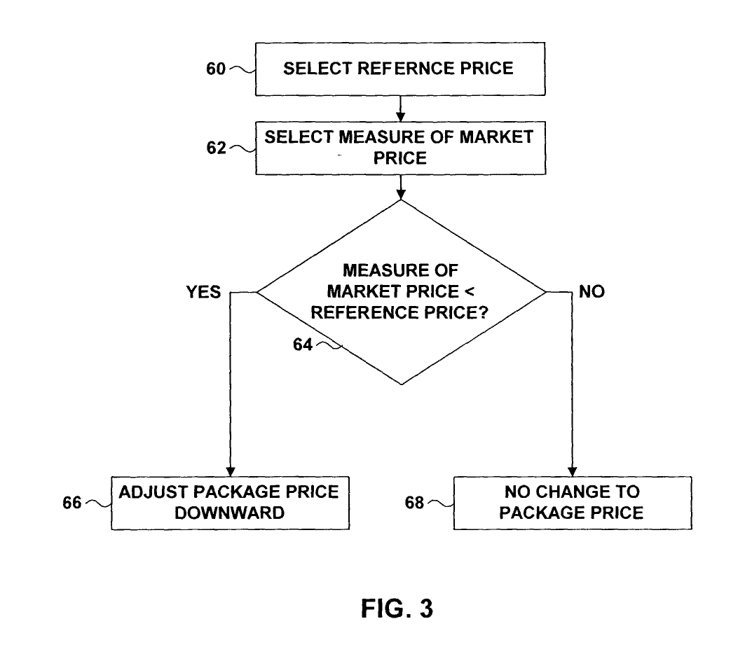

FIG. 3 is a flow diagram illustrating a method for assessing whether package price 14 will be reduced pursuant to price protection 18. The method includes selecting a reference price (60) and a measure of market price (62) and comparing the reference price to the measure of market price (64). When the measure of market price is less than the reference price, then the market is deemed to have gone down, and package price 14 is adjusted downward (66). When the measure of market price is greater than or equal to the reference price, then the market is deemed not to have gone down, and package price 14 remains unchanged (68).

Any reference price and any measure of market price may be selected. In one implementation of the invention, the reference price comprises a single futures price on an agreed-upon date, as reported by a trade organization such as the Chicago Board of Trade. If agricultural producer 10 intends to produce corn, for example, agricultural producer 10 and provider 12 may agree that the reference price may be the December corn futures settlement price on February 3. The reference price, once established, remains fixed. December corn futures prices are generally non-volatile prior to the start of the growing season, but may become more volatile as the growing season progresses. Accordingly, it may be reasonable for provider 12 to establish a sign-up date for participation by an agricultural producer 10 in the business method shown in FIG. 1. For example, provider 12 may require agricultural producer 10 and provider 12 to have reached an arrangement at least one week prior to the date that the reference price will be established.

The measure of market price may be any price measure that reflects the behavior of the market over the growing season. To avoid short-term volatility in the measure of market price, an averaging method may be applied to a plurality of futures prices. For example, the measure of market price for corn may be the arithmetic mean of the daily settlement prices of December corn futures from February 3 to May 30 of the present growing season. Agricultural producer 10 and provider 12 may agree to other starting and ending times for averaging. Agricultural producer 10 and provider 12 may also agree to compute the measure of market price by methods other than computation of the arithmetic mean.

When package price 14 is adjusted downward, any method for downward adjustment may be employed. In general, the amount of adjustment may be a function of the amount of decline in the market. For example, provider 12 may decrease package price 14 by one percent for every one cent that the measure of market price falls below the reference price. The invention also encompasses adjustment methods that are nonlinear.

The following examples illustrate the methods of the invention. As a first example, assume that Producer A plans to produce corn. On Jan. 24, 2003, Producer A agrees with Provider B to a package price that includes seed corn, herbicide and insecticide, at appropriate application rates. Provider B agrees to provide a performance guarantee, whereby Provider B agrees to bear input performance failure costs not covered by manufacturer or distributor guarantees, up to a maximum of five dollars per acre. Producer A and Provider B further agree to price protection, whereby the package price will be decreased by one percent for every one cent that the measure of market price falls below the reference price. The reference price will be the December 2003 corn futures settlement price on Feb. 3, 2003. The measure of the market price will be the arithmetic mean of the settlement prices of December 2003 corn futures from February 3 to May 30, 2003. Producer A further elects to defer the entire payment of the package price until the time of sale of the commodity.

On Feb. 3, 2003, the settlement price of December corn futures is $2.50 per bushel. In this example, $2.50 per bushel is the agreed reference price. As the growing season commences, Producer A experiences a performance problem with the herbicide, and requires a reapplication of herbicide on part of the land. The manufacturer of the herbicide compensates Producer A for the cost of the herbicide used in reapplication. As the growing season progresses, the measure of the market price declines, and on May 30, 2003, the measure of the market price stands at $2.35 per bushel, fifteen cents per bushel below the reference price.

Following harvest, Producer A sells the corn for $2.30 per bushel, five cents per bushel below the measure of the market price. The package price is reduced by fifteen percent, because the measure of the market price was fifteen cents per bushel below the reference price. From the proceeds of the sale, Producer A pays the package price to Provider B, less the fifteen percent adjustment. Producer A required no financial compensation pursuant to the performance guarantee, because the manufacturer of the herbicide compensated Producer A for the failure of performance by the herbicide.

Although Producer A may have been disappointed by a downturn in the market, Producer A realized financial benefits of price protection. Had the package price been a fixed price, Producer A would have been obligated to pay the full amount of the package price. As a consequence, Producer A would have a much smaller profit, and perhaps no profit at all. With price protection, Provider B bore some of the risk of market downturn, and Producer A had a better chance of making a profit.

As a second example, assume that Producer C enters into the same arrangement with Provider B as Producer A. Once again, $2.50 per bushel is the agreed reference price, as this is the settlement price of December corn futures on Feb. 3, 2003. In this scenario, however, the market price climbs, and on May 30, 2003, the measure of the market price stands at $2.60 per bushel, ten cents per bushel above the reference price. At harvest, Producer C sells the corn for $2.70 per bushel, ten cents per bushel above the measure of the market price. Assuming Producer C had no problems with input performance, Producer C is obligated to pay the full package price. Producer C did not require financial compensation pursuant to the performance guarantee, nor did Producer C require financial compensation pursuant to the price protection. Producer C did benefit, however, from having the financial protections afforded by the performance guarantee and price protection. Producer C further benefited from a high market price, and was able to wait until harvest before having to pay the package price.

As a third example, assume that Producer D enters into the same arrangement with Provider B as Producers A and C. Once again, $2.50 per bushel is the agreed reference price. In this scenario, Producer D experiences a serious herbicide performance failure, and the field requires a new application of herbicide. The manufacturer of the herbicide compensates Producer D by paying ten dollars for every acre that needs reapplication. Unfortunately, Producer D finds that the actual cost of herbicide is thirteen dollars per acre. Moreover, the market price for corn falls, and the measure of the market price turns out to be $2.10 per bushel.

At harvest, Producer D sells the corn for $2.10 per bushel. The season could have been a very costly one for Producer D, because of the unexpected costs of herbicide reapplication and because of the downturn in the market. Provider B, however, reduces the costs to Producer D by compensating Producer D for three dollars per acre, paying the costs of new herbicide not covered by the herbicide manufacturer. In addition, Producer D need not pay the full package price, but instead receives a forty percent discount on the package price. Producer D further benefits from making a deferred payment. What could have been a disastrous season for Producer D becomes a tolerable, and perhaps even profitable, season.

The above examples are for illustration. The performance guarantee and price protection terms may be different from those used in the examples.

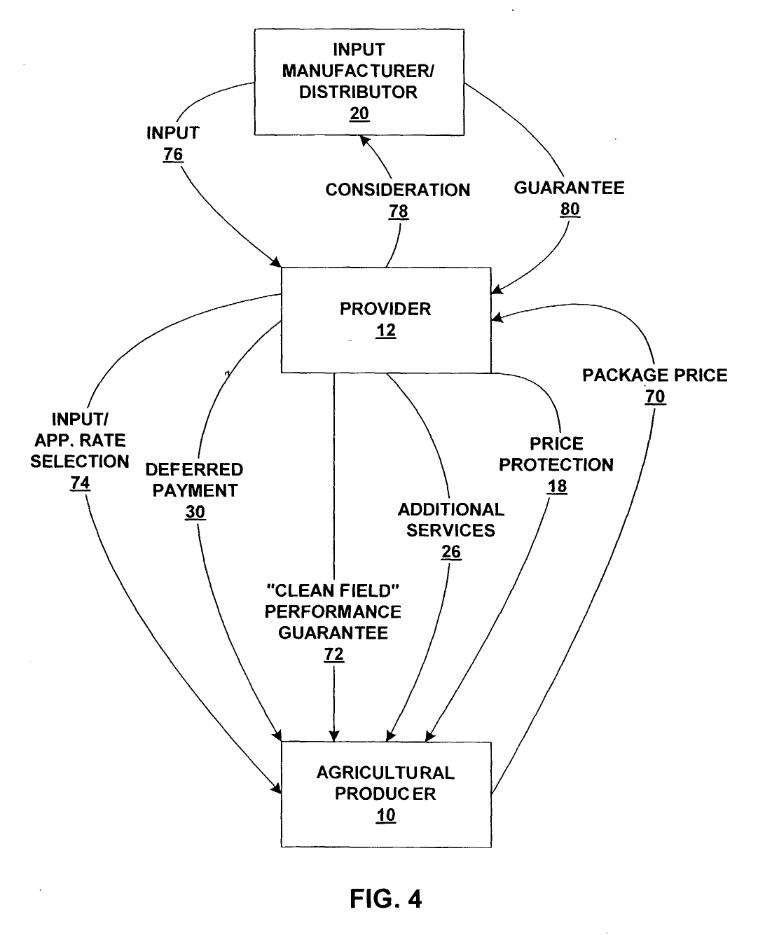

FIG. 4 is a diagram illustrating an alternative business method according to another embodiment of the invention. FIG. 4 is similar to FIG. 1, in that agricultural producer 10 and provider 12 enter into an arrangement, and that manufacturer/distributor 20 supplies one or more inputs. In addition, provider 12 provides price protection 18 and deferred payment terms 30.

The arrangement of FIG. 4 differs from the arrangement of FIG. 1, however, in that agricultural producer 10 grants broader discretion to provider 12. Provider 12 agrees to deliver a “clean field” to agricultural producer 10, i.e., to take action to control weeds and insects. Provider 12 may, for example, provide crop protection products to keep the field clean through the growing season. In exchange for package price 70 such as a per-acre fee, provider 12 guarantees that agricultural producer 10 will have a field that meets agreed-upon standards for weed and insect control.

The “clean field guarantee” 72 is an alternative form of performance guarantee. Instead of agreeing to compensate agricultural producer 10 for rescuing crops from input performance failure, provider 12 agrees to take action to remedy the input performance failure. When a herbicide or pesticide applied to a field fails to control a weed or insect adequately, for example, provider 12 reapplies herbicide or pesticide as needed to rescue the crops. In effect, agricultural producer 10 is at no financial risk of failure of herbicides or pesticides, because provider 12 promises to deliver a clean field. Package price 70 therefore represents the last dollar that agricultural producer 10 will spend in that season to keep the field clean.

Several recognized standards exist for determining whether a field is “clean.” In general, a clean field need not be totally free of weeds or pests, but the number of weeds or pests per unit of area is limited. In agriculture, “university guidelines” may represent the standard for whether a field is clean. University guidelines are usually developed in cooperation with agronomy departments of universities, and may take into account the crop, the area of the country in which the crop is produced, and the economics of chemical application to achieve thresholds of weed competitiveness or insect damage. Agricultural producer 10 and provider 12 need not adopt a university guideline as a standard for whether a field is clean, but may agree to adopt any other standard.

In general, a guarantee that a field will be clean is not a guarantee of a particular yield from that field. A clean field, however, generally produces a higher yield than a field that is not clean. Variables other than cleanliness may affect the yield, such as excess rain, drought, heat, hail, frost and other factors.

In order to determine package price 70 for a package of inputs and services that includes clean field guarantee 72, provider 12 may insist upon control over selected inputs and application rates. Unlike the arrangement of FIG. 1, in which agricultural producer 10 selects inputs 22 from a menu and selects application rates for the inputs, the arrangement of FIG. 4 provides discretion to provider 12 to select inputs and application rates 74. Agricultural producer 10 may apply the inputs to the field, or may agree to have provider 12 do so as an additional service 26.

Accordingly, provider 12 may purchase an input 76 from manufacturer/distributor 20, in exchange for consideration 78. The performance guarantee 80 associated with input 76, if any, inures to the benefit of provider 12.

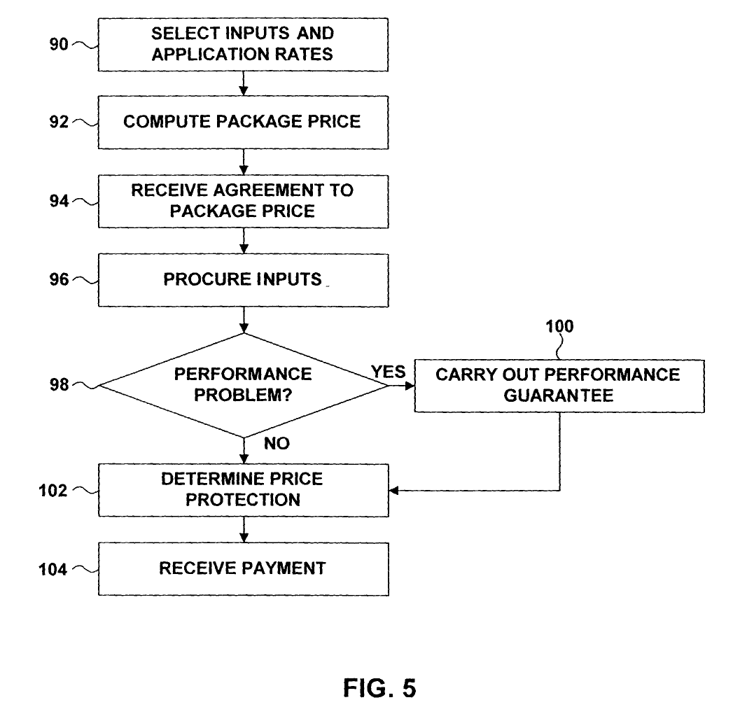

FIG. 5 is a flow diagram that illustrates the general sequence of events in accordance with the arrangement of FIG. 4. Agricultural producer 10 has asked provider 12 about the prospects of delivering a clean field, as defined by generally accepted guidelines. Provider 12 selects inputs that, in the judgment of provider 12, are likely to produce a clean field, along with application rates for the inputs (90). Provider 12 may also receive an order for additional services (not shown in FIG. 5). Provider 12 computes package price 70 (92) as a function of the inputs, the application rates and additional services, if any. Methods for computing package price 70 are described above, and may take into account consideration 78, the estimated cost of providing additional services 26, the costs associated with providing price protection 18 and deferred payment 30. Package price 70 may also take into account the cost associated with providing clean field performance guarantee 72.

The costs associated with providing performance guarantee 72 may be computed by any method for pricing the risk of carrying out the guarantee. The costs associated with performance guarantee 72 may depend, for example, upon a selected input 76, the guarantee 80 that accompanies input 76, and the stringency of the generally accepted guidelines. The costs associated with performance guarantee 72 may also depend upon the capability of agricultural producer 10 to apply inputs properly.

After agricultural producer 10 agrees to pay package price 70 in exchange for inputs, services, price protection 18 and performance guarantee 72 (94), provider 12 procures inputs 76 (96) from manufacturer/distributor 20, and may supply additional services as agreed (not shown in FIG. 5).

In the event of a performance problem (98), provider 12 carries out performance guarantee 72 (100). In particular, provider 12 takes whatever steps are appropriate to make the field clean. These steps may include additional applications of herbicide or pesticide, at no additional cost to agricultural producer 10.

After agricultural producer 10 harvests the crop and takes the crop to market, or at another agreed-upon date, provider 12 determines the amount of benefit to agricultural producer 10 from price protection 18 (102). Methods for adjusting package price 70 may be the same as described above in connection with FIGS. 1 and 2. Provider 12 receives payment from agricultural producer 10 of package price 70, as adjusted (104).

The following examples illustrate the methods of the invention shown in FIGS. 4 and 5. Assume that Producer E plans to produce corn on a particular field. Producer E enters into an arrangement with Provider B. The arrangement is similar to the arrangements between Provider B and Producers A, C and D, but unlike the other agricultural producers, Producer E wants a clean field performance guarantee. Provider B and Producer E agree that university guidelines will be applied to determine whether the field is clean. On Jan. 24, 2003, Producer E agrees with Provider B to a package price that includes seed corn, herbicide and insecticide, with inputs and application rates selected by Provider B.

In addition to the clean field performance guarantee, Provider B agrees to provide price protection, whereby the package price will be decreased by one percent for every one cent that the measure of market price falls below the reference price. The reference price will be the December 2003 corn futures settlement price on Feb. 3, 2003. The measure of the market price will be the arithmetic mean of the settlement prices of December 2003 corn futures from February 3 to May 30, 2003. Producer E further elects to defer the entire payment of the package price until the time of sale of the commodity.

In exchange for the inputs, price protection, performance guarantee and the right to defer payment, Producer E agrees to pay Provider B a package price of thirty-five dollars per acre. The package price is due at the time of harvest.

On Feb. 3, 2003, the settlement price of December corn futures is $2.50 per bushel, so $2.50 per bushel is the agreed reference price. As the growing season commences, Producer E and Provider B notice a problem with weeds in the field. The weed problem represents a serious threat to the field. Provider B, at its expense, procures additional herbicide to treat the field. Provider B may receive some compensation from the manufacturer or distributor of the herbicide as part of a product guarantee provided by the manufacturer or distributor.

The reapplication of herbicide is effective, but not effective enough to bring the field up to university guidelines. Accordingly, Provider B, at its expense, procures additional herbicide to treat the field. As a result of the additional treatments, the field is made clean.

The measure of market price is eventually found to be $2.35 per bushel, and Producer E sells the corn for $2.35 per bushel. The package price is reduced by fifteen percent, because the measure of the market price was fifteen cents per bushel below the reference price. From the proceeds of the sale, Producer E pays the package price to Provider B, less the fifteen percent adjustment.

In this example, Producer E realizes benefits of price protection and the benefits of the performance guarantee. Producer E further benefits from deferred payment. Two additional applications of herbicide were needed to make the field clean, but Producer E incurred no additional expense for making the field clean.

As another example, assume that Producer F enters into the same arrangement with Provider B as Producer E. Producer F agrees with Provider B to a package price of $35.00 per acre for inputs and application rates selected by Provider B, price protection, deferred payment and a clean field performance guarantee.

Once again, $2.50 per bushel is the agreed reference price. During the growing season, Producer F notices a few weeds in the field, but the field is still clean according to the university guidelines. The measure of market price is eventually found to be $2.50 per bushel, and Producer F sells the corn for $2.50 per bushel. Producer F is entitled to no reduction in the package price, because the market did not decline.

Producer F benefited during the growing season from not having to make any additional payments to keep the field clean. As it turned out, the field did not need any additional applications of herbicide or pesticide to keep the field clean, but Producer F nevertheless had the peace of mind in knowing what it would cost to have a clean field. Provider B was fortunate, because Provider B did not need to incur any additional costs to keep the field clean.

Producer F pays Provider B the package price of $35.00 per acre. In situations in which Provider B incurred no additional costs to keep the field clean, the invention may include a credit to Producer F. The credit may represent a sharing of the benefits of a clean field. In addition, where Producer F is responsible for the first application of herbicides or pesticides, the refund may also provide an incentive to Producer F to make a careful application.

When agricultural producer 10 sets up an arrangement with provider 12 as shown in FIGS. 1 or 4, agricultural producer 10 may or may not meet in person with a representative of provider 12. Agricultural producer 10 may order a package of inputs, select appropriate application rates and select additional services and other terms via a network, such as the Internet.

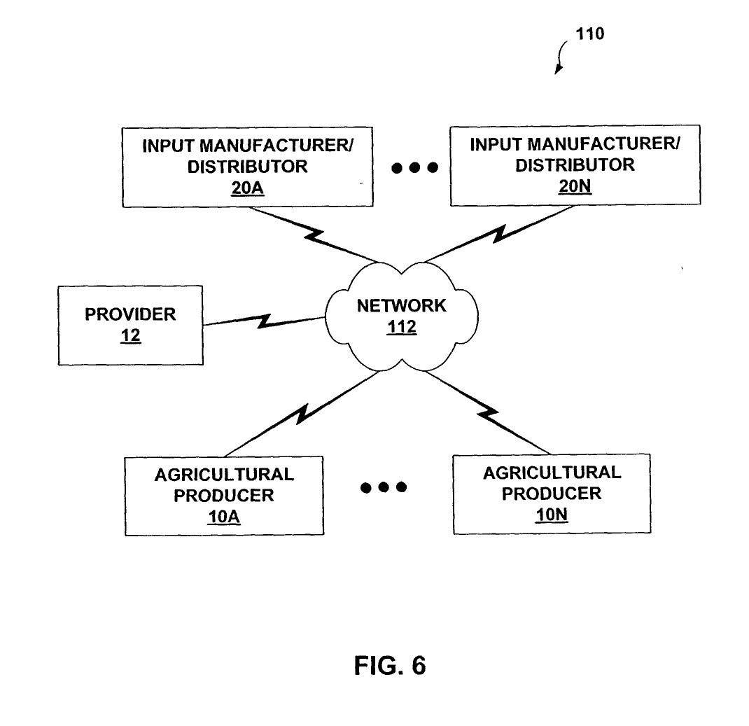

FIG. 6 is a block diagram illustrating a system 110 for centrally managing arrangements between provider 12 and one or more agricultural producers 10A through 10N. More specifically, authorized agricultural producers 10A through 10N interact with provider 12 via network 112. In addition, one or more input manufacturers or distributors 20A through 20N may interact with provider 12 via network 112.

Provider 12 may use system 110 to carry out the methods described above. Provider 12 may, for example, offer a choice of performance guarantees. When a particular agricultural producer selects a per-acre guarantee, then provider 12 may present that agricultural producer with a menu of inputs. Provider 12 may receive menu selections from the agricultural producer, along with application rates, and orders for additional services 26, if any. When the agricultural producer selects a clean field performance guarantee, however, the ability of the agricultural producer to select inputs from a menu and to select application rates may be disabled.

On the basis of the selected performance guarantee, selected inputs, the selected application rates, the selected performance guarantee and the selected additional services, if any, provider 12 computes package price 14. As noted above, package price 14 may be computed using any of several methods.

In some embodiments of the invention, agricultural producers 10A through 10N may be offered a choice of price protection options as well. For example, agricultural producers 10A through 10N may be allowed to specify a reference price and a measure of market price, or may be offered an option of paying an increased package price should the measure of market price rise above the reference price. Package price 14 may reflect the selections of performance guarantees.

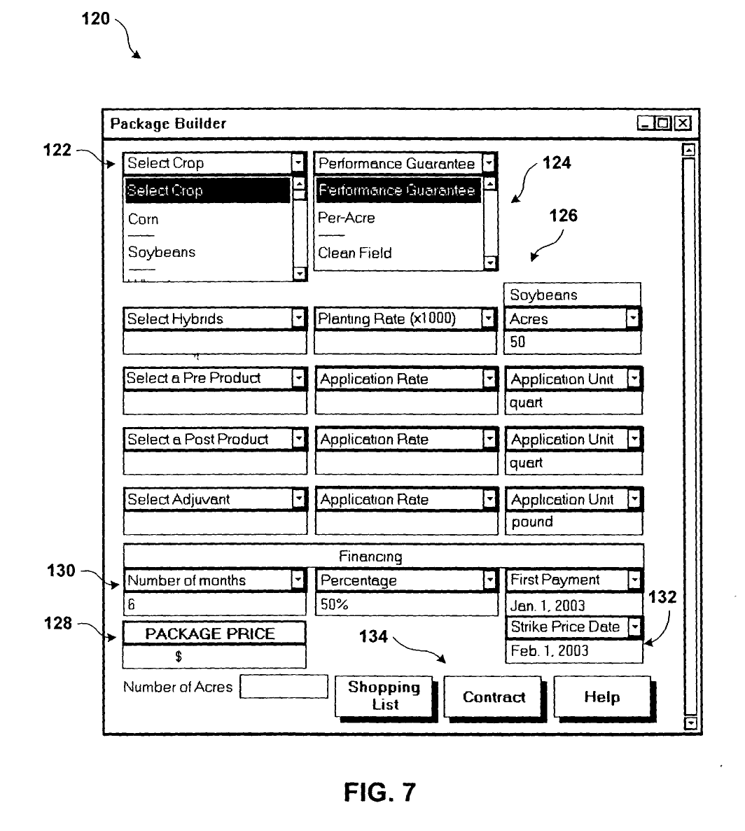

FIG. 7 is a screen shot of an exemplary display screen 120 that agricultural producer 10 may see when contacting provider 12 via network 112. Display screen 120 illustrates some of the options that may be presented to agricultural producer 10. Agricultural producer 10 may be invited to select the agricultural product and the desired price protections with drop-down menus 122, 124. Agricultural producer 10 may be offered a set of information fields 126 as a function of the selected agricultural product and price protection. Information fields 126 may include menus of inputs, or requests for information about agricultural producer 10, such as the number of acres to be produced.

On the basis of the information provided by agricultural producer 10, a package price 128 may be presented. Display screen 120 may submit a query 130 to agricultural producer 10 about whether agricultural producer 10 wishes to prepay part or all of the package price. In addition, display screen 120 may offer the option 132 to agricultural producer 10 to select a strike price that will represent the reference price. Display screen 120 may further provide links 134 to additional information or features.

The inputs, whether selected by agricultural producers 10A through 10N or provider 12, may be ordered automatically via network 112 from manufacturers/distributors 20A through 20N. In addition, manufacturers/distributors 20A through 20N may provide pricing and performance guarantee information to provider 12 via network 112.

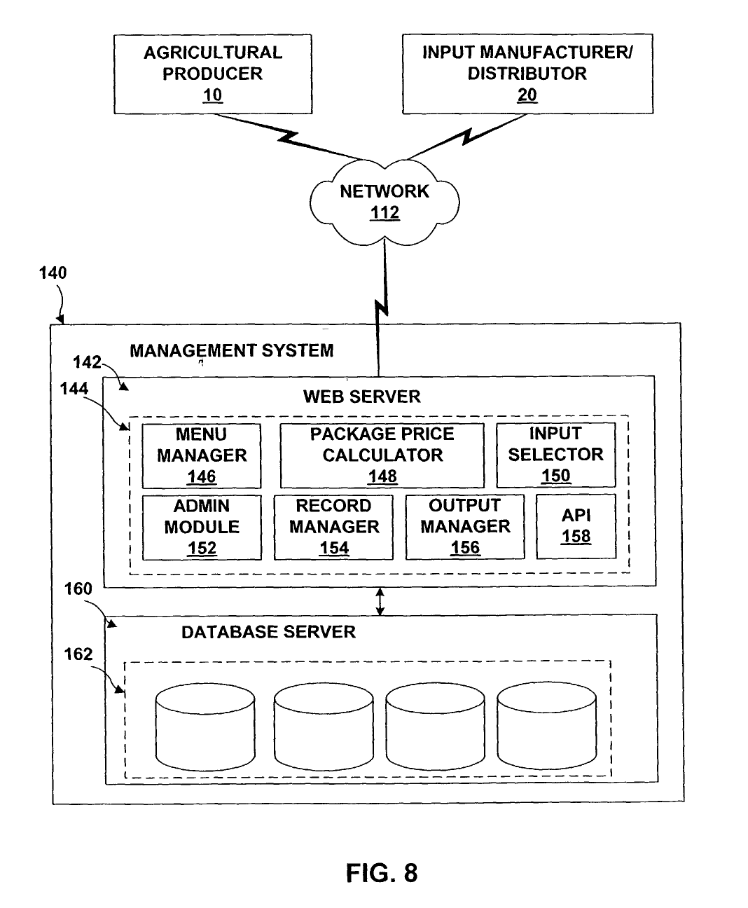

FIG. 8 is a block diagram illustrating a management system 140 operated by provider 12 in further detail. Web servers 142 provide an interface by which a typical agricultural producer 10 and a typical manufacturer/distributor 20 communicate with management system 140 via network 112. In one configuration, web servers 142 execute web server software, such as Internet Information Server™ from Microsoft Corporation, of Redmond, Wash. As such, web servers 142 provide an environment for interacting with agricultural producer 10 according to software modules 144, which can include Active Server Pages, web pages written in hypertext markup language (HTML) or dynamic HTML, Active X modules, Lotus scripts, Java scripts, Java Applets, Distributed Component Object Modules (DCOM) and the like. Although illustrated as “server side” software modules executing within an operating environment provided by web server 142, software modules 144 could readily be implemented as “client-side” software modules executing on computing devices used by agricultural producer 10 or manufacturer/distributor 20. Software modules 144 could, for example, be implemented as Active X modules executed by a web browser executing on the computing devices.

Software modules 144 may include a number of modules including menu manager 146, package price calculator 148, input selector 150, administration (Admin) module 152, record manager 154, output manager 156 and application programming interface (API) 158. Software modules 144 interact with data server 160 to access a number of data stores 162. Data stores 162 store data including input prices, input availability, input guarantees, agricultural producer data, manufacturer/distributor data, and so forth. Each data store 162 may be implemented in a number of different forms including a data storage file, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Furthermore, although illustrated separately, data stores 162 could be combined into a single database or other data storage structure. Data stores 162 could, for example, be implemented as a single relational database such as SQL Server from Microsoft Corporation.

The invention may be embodied as a computer-readable medium comprising instructions for causing a programmable processor carry out the methods described above. In particular, the invention may be embodied as a computer-readable medium comprising instructions that carry out the instructions of software modules 144, especially the instructions of menu manager 146, package price calculator 148 and input selector 150.

Agricultural producer 10 may interact with management system 140 via a display such as display 120 shown in FIG. 7. Menu manager 146 may generate and control the information presented to agricultural producer 10, and may receive the selections and other data entered by agricultural producer 10. When menu manager 146 has received sufficient information to compute a package price, package price calculator 148 may compute the price of the selected package. Package price calculator 148 may further compute adjustments to the package price pursuant to the terms of the price protection.

When agricultural producer 10 selects a clean field performance guarantee, provider 12 may have the discretion to select inputs and application rates. Input selector 150 selects inputs and application rates that, in the judgment of provider 12, will enable provider 12 to deliver a field substantially free of weeds and insects. Input selector 150 may base the selections upon several criteria, such as past input performance, input guarantees, input availability, the location of the field, or other factors pertinent to agricultural producer 10.

Administration (admin) module 152 presents an interface by which authorized users, such as system administrators, configure management system 140. Record manager 154 stores information about agricultural producers 10 in data stores 162. Information such as name, billing address, past purchases and the like need not be reentered at the outset of each growing season. Output manager 156 controls output aspects, such as preparation of confirmation documents, order forms or reports for provider 12. API 158 provides the ability to establish direct connections with external computing devices, allowing such devices to automatically control management system 140. A front-end module, such as a script or command line interface provided by the remote computing device, for example, may communicate with API 158 directly, bypassing the interfaces presented by other software modules 144.

The invention may have many advantages. In addition to the benefits of price protection, performance guarantee and deferred payment, the agricultural producer benefits from the convenience of the methods. The convenience may take the form of purchasing inputs from a menu, or of allowing a provider to select the inputs and application rates. The package price may be computed as a per-acre rate that includes a variety of the inputs for producing an agricultural product.

Convenience is an advantage to the provider as well. Although the provider assumes some risks associated with production of the agricultural product, the provider knows what inputs and application rates will be employed, and can therefore plan for the risks.

Input suppliers such as manufacturers and distributors may also benefit from the convenience afforded by the invention. A single provider, serving many agricultural producers, may procure large quantities of an input from an input supplier. As a result, an input supplier may realize an increase in the volume of business.

A number of embodiments of the present invention have been described. Nevertheless, various modifications may be made without departing from the scope of the invention. For example, the invention is not limited to the performance guarantees and price protection methods described above. In addition, a single entity may be both a provider and a manufacturer or distributor of inputs.

In addition, the invention may be adapted to other agricultural products, such as livestock. For livestock, inputs may include the animals themselves, as well as feed and medicine. A provider may provide a performance guarantee in terms of average daily weight gain, for example. Price protection may be computed in a manner similar to that employed for crops, with the reference price and measure of market price being a function of agreed-upon futures prices.

Furthermore, the invention encompasses price protection that is based upon commodities or agricultural products other than the one being produced by the agricultural producer. For example, the agricultural producer may desire to raise corn, but may agree with the provider that the reference price and measure of market price will be a function of soybean futures prices, rather than corn futures prices. Such an arrangement may be desirable to an agricultural producer that produces more than one kind of agricultural product, or an agricultural producer that is concerned about a loss of opportunity by choosing to produce one agricultural product rather than another. These and other embodiments are within the scope of the following claims.

1. A method comprising:
selecting a reference price for an agricultural product at a first time;
selecting a measure of market price at a second time; and
reducing a package price when the measure of market price is below the reference price, the package price including the price of at least one input for production of an agricultural product.

2. The method of claim 1, wherein the reference price comprises a futures price of a commodity, the futures price being fixed at the first time.

3. The method of claim 1, wherein the measure of market price is a function of a plurality of futures prices, each futures price being fixed no later than the second time.

4. The method of claim 3, wherein the measure of market price is a function of the arithmetic mean of the plurality of futures prices.

5. The method of claim 1, further comprising guaranteeing the performance of the input.

6. The method of claim 5, wherein guaranteeing the performance of the input comprises making a payment, in the event of a performance failure of the input, to an agricultural producer affected by the performance failure.

7. The method of claim 6, wherein a supplier of the input guarantees the performance of the input, the method further comprising making the payment after the supplier has carried out the guarantee made by the supplier.

8. The method of claim 5, wherein guaranteeing the performance of the input comprises taking action to remedy a performance failure of the input.

9. The method of claim 1, further comprising receiving at least a portion of the reduced package price after the second time.

10. The method of claim 1, further comprising purchasing the input from an input supplier.

11. The method of claim 1, further comprising increasing a package price when the measure of market price is above the reference price.

12. A method comprising:
prior to a growing season, promising to take action to make a field clean during the growing season; and
receiving a package price in exchange for the promise, the package price including the price of at least one input for production of an agricultural product on the field.

13. The method of claim 12, further comprising selecting the input prior to the growing season, the input to be applied to the field prior to the harvest.

14. The method of claim 12, further comprising:
selecting a reference price for an agricultural product at a first time;
selecting a measure of market price at a second time; and
reducing the package price when the measure of market price is below the reference price.

15. The method of claim 12, further comprising:
selecting a reference price for an agricultural product at a first time;
selecting a measure of market price at a second time; and
increasing the package price when the measure of market price is above the reference price.

16. The method of claim 12, wherein at least a portion of the package price is received after the growing season.

17. A method comprising:
presenting a menu of agricultural product inputs to an agricultural producer;
receiving a selection of inputs from the menu by the agricultural producer;
computing a package price as a function of the selected inputs;
selecting a reference price for an agricultural product at a first time;
selecting a measure of market price at a second time; and
reducing the package price when the measure of market price is below the reference price.

18. The method of claim 17, further comprising guaranteeing the performance of at least one selected input.

19. The method of claim 17, wherein guaranteeing the performance of the selected input comprises making a payment, in the event of a performance failure of the input, to an agricultural producer affected by the performance failure.

20. The method of claim 17, further comprising increasing the package price when the measure of market price is above the reference price.

21. A method comprising:
computing a package price including a price for a guarantee of performance of at least one agricultural product input;
selecting a reference price for an agricultural product at a first time;
selecting a measure of market price at a second time; and
reducing the package price when the measure of market price is below the reference price.

22. The method of claim 21, wherein the reference price comprises a futures price of a commodity, the futures price being fixed at the first time.

23. The method of claim 21, wherein the measure of market price is a function of a plurality of futures prices, each futures price being fixed no later than the second time.

24. The method of claim 23, wherein the measure of market price is a function of the arithmetic mean of the plurality of futures prices.

25. The method of claim 21, wherein the guarantee of performance of the input comprises a payment in the event of a performance failure of the input.

26. The method of claim 25, wherein a supplier of the input guarantees the performance of the input, the method further comprising making the payment after the supplier has carried out the guarantee made by the supplier.

27. The method of claim 21, wherein the guarantee of performance of the input comprises taking action to remedy a performance failure of the input.

28. The method of claim 21, further comprising receiving at least a portion of the reduced package price after the second time.

29. The method of claim 21, further comprising purchasing the input from an input supplier.

30. The method of claim 21, further comprising increasing the package price when the measure of market price is above the reference price.

31. A system comprising:
a menu manager that presents a menu of agricultural product inputs to an agricultural producer and receives a selection of inputs from the menu by the agricultural producer; and
a package price calculator that computes a package price as a function of the selected inputs and that reduces the package price when a measure of market price selected at a second time is below a reference price selected at a first time.

32. The system of claim 31, wherein the menu manager receives an application rate for at least one selected input, and wherein the package price calculator computes the package price as a function of the application rate.

33. The system of claim 31, wherein the package price calculator increases the package price when the measure of market price is above the reference price.

34. A system comprising:
an input selector that selects at least one agricultural product input from a set of agricultural product inputs; and
a package price calculator that computes a package price as a function of the selected inputs and that reduces the package price when a measure of market price selected at a second time is below a reference price selected at a first time.

35. The system of claim 34, wherein the input selector selects an application rate for at least one selected input, and wherein the package price calculator computes the package price as a function of the application rate.

36. The system of claim 34, wherein the package price calculator increases the package price when the measure of market price is above the reference price.

37. A computer-readable medium comprising instructions for causing a programmable processor to:
present a menu of agricultural product inputs to an agricultural producer;
receive a selection of inputs from the menu by the agricultural producer;
compute a package price as a function of the selected inputs; and
reduce the package price when a measure of market price selected at a second time is below a reference price selected at a first time.

38. The medium of claim 37, the instructions further causing the processor to:
receive an application rate for at least one selected input; and
compute the package price as a function of the application rate.

39. A computer-readable medium comprising instructions for causing a programmable processor to:
select at least one agricultural product input from a set of agricultural product inputs;
compute a package price as a function of the selected inputs; and
reduce the package price when a measure of market price selected at a second time is below a reference price selected at a first time.

40. The medium of claim 39, the instructions further causing the processor to:
select an application rate for at least one selected input; and
compute the package price as a function of the application rate.

41. A system comprising:
a database storing information about a set of agricultural product inputs; and
a server that presents an interface to an agricultural producer for selecting at least one input from the set in response to a selection by the agricultural producer of a first performance guarantee and that selects at least one input from the set in response to a selection by the agricultural producer of a second performance guarantee.

42. The system of claim 41, wherein the server computes a package price as a function of the selected inputs.

43. The system of claim 42, wherein the server reduces the package price when a measure of market price selected at a second time is below a reference price selected at a first time.

44. A computer-readable medium comprising instructions for causing a programmable processor to:
store information about a set of agricultural product inputs;
present an interface to an agricultural producer for selecting at least one input from the set in response to a selection by the agricultural producer of a first performance guarantee; and
select at least one input from the set in response to a selection by the agricultural producer of a second performance guarantee.

45. The medium of claim 44, the instructions further causing the processor to compute a package price as a function of the selected inputs.
